(19) United States
(12) Patent Application Publication
(10) Pub. No.: US 2008/0067027 A1
(43) Pub. Date: Mar. 20, 2008

(54) Electromagnetic clutch

(75) Inventor: Shen Zhao, Miyota-machi (JP)

Correspondence Address: BACON & THOMAS, PLLC, 625 SLATERS LANE, FOURTH FLOOR, ALEXANDRIA, VA, 22314, US

(73) Assignee: MINEBEA CO., LTD., Nagano-ken (JP)

(21) Appl. No.: 11/892,982

(22) Filed: Aug. 29, 2007

(30) Foreign Application Priority Data
Sep. 1, 2006 (JP) 2006/238374

(51) Int. Cl. F16D 27/00

(52) U.S. Cl. 192/84.96

(57) ABSTRACT

An electromagnetic clutch comprising a stator yoke, a rotor and an electromagnetic coil, the stator yoke comprising a thick-walled cylindrical portion and an annular large-outside-diameter portion contiguous at an end thereof perpendicularly to the thick-walled cylindrical portion, a radial section cut from the central axis of the cylindrical portion being L-shaped, a stepped portion being formed at a radially intermediate position of the annular large-outside-diameter plate portion, the stepped portion having an annular vertical surface perpendicular to the radial direction, the rotor comprising an annular small-outside-diameter plate portion, an inner cylindrical portion contiguous at an end thereof perpendicularly to an inner end of the annular small-outside-diameter plate portion, and an outer cylindrical portion contiguous at an end thereof perpendicularly to an outer end of the annular small-outside-diameter portion, the rotor covering an upper end side of the thick-walled cylindrical portion of the stator yoke and also covering the electromagnetic coil, the inner cylindrical portion of the rotor being loosely fitted inside the thick-walled cylindrical portion, the outer cylindrical portion of the rotor being disposed so that the inside of an end of the outer cylindrical portion confronts the annular vertical surface perpendicular to the radial direction of the stator yoke. The rotor is of a simple configuration satisfying required magnetic characteristics, further, it is light in weight, easy to manufacture and can be applied to a variety of driving force transfer mechanisms.

### BACKGROUND OF THE INVENTION

1. Field of the Invention

The present invention relates to an electromagnetic clutch provided with a rotor having a simple structure and a U-shaped section, and a yoke having an L-shaped section. Both the rotor and the stator can be easily fabricated.

2. Description of the Prior Art

A rotor of a conventional electromagnetic clutch is integrally provided with, for example, a pulley having a plurality of V-grooves for entraining a multistage V-belt thereon in order to receive a rotational force from a drive source (e.g., engine). The V-grooves are of a complicated structure and therefore have heretofore been formed mainly by casting (see, for example, Japanese Patent Application Laid-Open No. 304221/1990) or by forging (see, for example, Japanese Patent Application Laid-Open No. 114240/1996).

In an example of casting described in Patent Literature 1, a clutch rotor is formed using a magnetic material such iron and has an annular shape of a U-shaped section which covers an exciting coil from a front side, and its outer periphery surface is formed with a pulley on which a multistage V-belt is entrained.

In an example of forging described in Patent Literature 2, an inner wall, an outer wall and an intermediate ring of a rotor are provided as separate members and are rendered integral with one another while filling a non-magnetic material between adjacent such members, and magnetic shielding portions are formed by the non-magnetic material. The outer wall of the rotor is integrally provided with a pulley for entraining a belt thereon.

In a non-bridge type rotor, positioning such as centering is needed at the time of joining the inner wall, intermediate ring and outer wall through non-magnetic material. Therefore, mounting workability is poor and the number of parts is large, thus resulting in increase of the manufacturing cost. In the case of forging, a plurality of forged products are joined together by welding.

It is also possible to form a sheet metal pulley by deep drawing a plate into a cup shape (see, for example, Japanese Utility Model Application Laid-Open No. 87736/1994). In this case, since the pulley is formed by deep stretch drawing, it is impossible to obtain such a rotor having a U-shaped section as in the case of forging, and all that can be done by machining is merely forming a V-groove on a flat plate. Thus, the sheet metal pulley must be fixed firmly to the rotor with use of a large number of bolts.

However, all of the above conventional methods are unsuitable for a mass production line because manufacturing equipment and time are needed. More particularly, a casting process involves the steps of forming a rotor core, forming a mold with use of the core and sand, melting such a material as ingot, pouring the molten material into the mold, subsequent sprue shearing upon cooling, forming a sprue, surface sanding, and shipping. None of the steps can be completed in a simple manner. Besides, a wide place is necessary to lay out the equipment, such as an electric furnace or the like, an apparatus for loading sand and forming molds. Moreover, cast or forged products are inevitably heavy because they are thick. To bear this weight, a yoke, which forms a magnetic path in combination with the rotor, is required to have a reinforced structure and inevitably becomes larger in size and complicated despite the existence of a demand for reduction in size of the yoke structure. Another part for supporting a clutch body also becomes necessary.

Further, primary processed products formed in a divided manner must be joined together with bolts or by welding or the like so as to give a desired shape as a whole. Thus, the conventional rotor processing method involves various problems.

For such reasons, the rotor of the electromagnetic clutch described above cannot be manufactured on a mass production line, and the manufacturing cost thereof becomes high. As another factor, in the conventional electromagnetic clutch, the cost becomes high because the number of parts used is large; besides, although as means for rotating the rotor there are other means than the use of a V-belt, there is a tendency to the fabrication of a rotor provided with a V-belt pulley, with a consequent decrease of the number of parts employable in common even when the clutch is viewed as a whole. In addition, the structure of the conventional rotor does not satisfy such conditions as lightweight, easy manufacture and capability of coping with a variety of driving force transfer mechanisms.

### SUMMARY OF THE INVENTION

The present invention has been made in the light of the above problems and it is an object of the present invention to provide an electromagnetic clutch having a rotor of a simple configuration satisfying required magnetic characteristics, the rotor being light in weight, easy to manufacture and applicable to a variety of driving force transfer mechanisms.

For achieving the above object the present invention adopts the following means.
(1) An electromagnetic clutch comprising a stator yoke, a rotor, and an electromagnetic coil, the stator yoke comprising a thick-walled cylindrical portion and an annular large-outside-diameter plate portion contiguous at an end thereof perpendicularly to the thick-walled cylindrical portion, a radial section cut from the central axis of the cylindrical portion being L-shaped, a stepped portion being formed at a radially intermediate position of the annular large-outside-diameter plate portion, the stepped portion having an annular vertical surface (axial surface) perpendicular to the radial direction, the rotor comprising an annular small-outside-diameter plate portion, an inner cylindrical portion contiguous at an end thereof perpendicularly to an inner end of the annular small-outside-diameter plate portion, and an outer cylindrical portion contiguous at an end thereof perpendicularly to an outer end of the annular small-outside-diameter plate portion, the rotor covering an upper end side of the thick-walled cylindrical portion of the stator yoke and also covering the electromagnetic coil, the inner cylindrical portion of the rotor being loosely fitted inside the thick-walled cylindrical portion, the outer cylindrical portion of the rotor being disposed so that the inside of an end of the outer cylindrical portion confronts the annular vertical surface perpendicular to the radial direction of the stator yoke.
(2) An electromagnetic clutch according to the above (1), wherein an axial end of the outer cylindrical portion of the rotor is formed with a lower end surface and a slant surface contiguous to each other.
(3) An electromagnetic clutch according to the above (1) or (2), wherein the annular large-outside-diameter plate portion of the stator yoke has a long-diameter portion, the long-diameter portion including a connecting portion for fixing the whole of the electromagnetic clutch to a base, and the annular vertical surface perpendicular to the radial direction is formed at an intermediate position in the radial direction of the long-diameter portion.
(4) An electromagnetic clutch according to any one of the above (1) to (3), wherein the inner cylindrical portion of the rotor is supported by a shaft through small-diameter bearings, the shaft being supported by an inner surface of the thick-walled cylindrical portion of the stator yoke through a large-diameter bearing.
(5) An electromagnetic clutch according to any one of the above (1) to (4), wherein in a section taken along a plane perpendicular to a rotary shaft, the sum of a cross-section area of the inner cylindrical portion of the rotor and that of the thick-walled cylindrical portion of the stator yoke is almost equal to a cross-section area of the outer cylindrical portion of the rotor.

The electromagnetic clutch of the present invention comprises a rotor of a U-shaped section formed by pressing a metallic plate and a stator yoke of an L-shaped section. In comparison with the conventional electromagnetic clutches, the electromagnetic clutch of the present invention is simple in configuration and easy to machine and assemble.

Since the electromagnetic coil is disposed in contact with both the thick-walled cylindrical portion and the annular large-outside-diameter plate portion of the stator yoke having an L-shaped section, magnetic flux generated by the electromagnetic coil can be allowed to pass effectively through both the thick-walled cylindrical portion and the annular large-outside-diameter plate portion of the stator yoke positioned closest to the electromagnetic coil. Since the thick-walled cylindrical portion is of a large width, magnetic resistance is low and so is leaking magnetic flux. Besides, since the section of the stator yoke is L-shaped, the magnetic flux generated by the electromagnetic coil of a quadrangular section including both square and rectangular shapes) can be effectively utilized.

The rotor is formed from a single magnetic metal plate by means of stretch draw pressing, so that not only its magnetic characteristics can be controlled more easily, but also the manufacture thereof becomes easier and the structure thereof becomes simpler. Particularly, since machining of all the portions other than a frictional surface and a bearing-mounting hole can be done by press working, the rotor can be mass-produced automatically on a mass production line. In order to make magnetic flux density constant in the magnetic circuit, the sum of the cross-section areas of the inner cylindrical portion and the thick-walled cylindrical portion of the stator yoke, each of which constitutes a part of the magnetic circuit, is made equal to the cross-section area of the outer cylindrical portion, whereby it is possible to improve magnetic characteristics.

Since the rotor is formed so as to have a U-shaped section, the inner cylindrical portion can be loosely fitted inside the thick-walled cylindrical portion and the annular small-outside-diameter plate portion can be disposed in opposition to an upper end of the thick-walled cylindrical portion of the stator yoke and an upper end of the electromagnetic coil. Further, the outer cylindrical portion can be opposed to the annular vertical surface formed at a radially intermediate position of the annular large-outside-diameter plate portion of the stator yoke while covering the side surface of the electromagnetic coil.

Since the inner cylindrical portion is loosely fitted inside the thick-walled cylindrical portion, the inner cylindrical portion and the thick-walled cylindrical portion confront each other over a wide area, so that the leakage of magnetic flux generated by the electromagnetic coil is diminished and the cross-section area of the magnetic path becomes wider, whereby it is possible to diminish the magnetic resistance.

Since the inner cylindrical portion is disposed inside the thick-walled cylindrical portion, it is possible to increase the axial length of the inner cylindrical portion. Accordingly, the bearing mounting area becomes longer and the rotor can be supported to ensure stable rotation while resisting to an external imbalance torque.

Since the outer cylindrical portion covers the side surface of the electromagnetic coil, magnetic flux leakage from the electromagnetic coil is diminished. Besides, since the slant surface formed end of the electromagnetic coil confronts the stepped portion of the stator yoke, it is possible to restrict the path of transmitted magnetic flux and hence possible to suppress the generation of unnecessary axial attractive force.

### BRIEF DESCRIPTION OF THE DRAWINGS

FIG. 1 is a longitudinal section view of an electromagnetic clutch according to a first embodiment of the present invention.

FIG. 2 is a plan view of a stator yoke shown in FIG. 1.

FIG. 3 is a diagram showing an example of combination of an outer cylindrical portion of a rotor and a stepped portion of the stator yoke, in which FIG. 3(a) shows an example in which an end of the outer cylindrical portion is not subjected to machining and FIG. 3(b) shows an example in which a slant surface is formed on an outer side surface of the end of the outer cylindrical portion.

FIG. 4 is a construction diagram of a stator yoke according to a second embodiment of the present invention, in which FIG. 4(a) is a top view and FIG. 4(b) is a cross-section view taken along line A-A in FIG. 4(a).

FIG. 5 is a configuration diagram of a stator yoke according to a third embodiment of the present invention.

FIG. 6 is a cross-section view of the inner and the outer cylinder portions of the rotor, and the thick-walled cylindrical portion of the stator yoke taken along line X-X in FIG. 5.

### DETAILED DESCRIPTION OF PREFERRED EMBODIMENTS

Embodiments of the present invention will be described in detail hereinunder with reference to the accompanying drawings.

In the drawings, the same constituent portions are identified by the same reference numerals, and explanations thereof will be omitted.

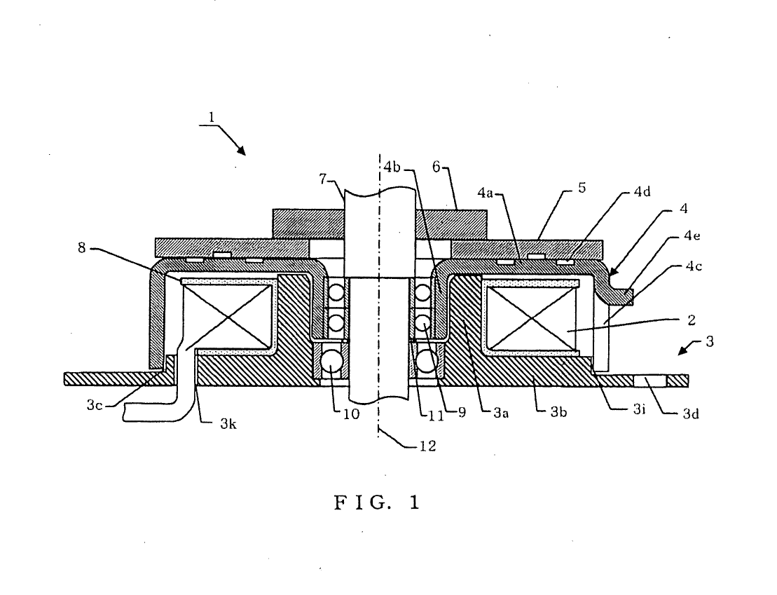

Referring to FIG. 1, an electromagnetic dutch 1 embodying the present invention mainly includes a stator yoke 3 provided with an electromagnetic coil 2, a rotor 4, an armature 5, and a shaft 7 which supports the armature 5 through a hub 6.

The electromagnetic coil 2 is accommodated within a coil bobbin 8 of a U-shaped section and is fixed by caulking an upper end of a thick-walled portion of the stator yoke. The electromagnetic coil 2 is formed in an annular shape.

The stator yoke 3 is formed of a magnetic metal material and has an L-shaped section so as to accommodate the annular electromagnetic coil 2 therein. The L-shaped section is constituted by a thick-walled cylindrical portion 3a and an annular large-outside-diameter plate portion 3b, which is contiguous at an end thereof perpendicularly to one end of the thick-walled cylindrical portion 3a. The L-shaped section means that the shape of stator yoke 3 likes letter U in a radial section cut from the center of the axis of the stator yoke.

The annular large-outside-diameter plate portion 3b is provided with a stepped portion 3c on the extending side of the thick-walled cylindrical portion 3a, the stepped portion 3c having an annular vertical surface (axial surface) 3i perpendicular to the radial direction. For fixing the annular large-outside-diameter plate portion 3b to an object device, e.g., an automobile body (not shown), mounting holes 3d are formed in the annular large-outside-diameter plate portion 3b at positions near the outer periphery. The annular large-outside-diameter plate portion 3b is also formed with a draw-out hole 3k for leading out a lead wire of the electromagnetic coil2. The shaft 7 is mounted on an inner lower surface of the thick-walled cylindrical portion 3a of the stator yoke 3 through a large-diameter bearing 10.

The rotor 4 is formed into a U-shaped section for example by cold stretch drawing from a single magnetic metal plate. The U-shaped section means that the shape of rotor 4 likes letter U in a radial section cut from the center of the axis of the rotor 4.

The U-shaped section of the rotor 4 is constituted by an annular small-outside-diameter plate portion 4a, an inner cylindrical portion 4b which is contiguous at an end thereof perpendicularly to an inner end of the annular small-outside-diameter plate portion 4a, and an outer cylindrical portion 4c which is contiguous at an end thereof perpendicularly to an outer end of the annular small-outside-diameter plate portion 4a.

The open side of rotor 5 is disposed opposite to the armature so as to accommodate therein both the thick-walled cylindrical portion 3a of the stator yoke 3 and the electromagnetic coil 2 adjacent thereto. The rotor 4 covers the upper end side of the thick-walled cylindrical portion 3a of the stator yoke 3 and the electromagnetic coil 2. The inner cylindrical portion 4b is loosely fitted inside the thick-walled cylindrical portion 3a and an end of the outer cylindrical portion 4c is disposed in opposition to the annular vertical surface 3i of the stepped portion 3c of the stator yoke 3.

The rotor 4 is supported rotatably by the shaft 7 through small-diameter bearings 9 mounted inside the inner periphery of the rotor 4. A spacer 11 is disposed between the small-diameter bearings 9 and the large-diameter bearing 10.

The annular small-outside-diameter plate portion 4a of the rotor 4 is formed with magnetic shielding portions 4d by blanking in positions corresponding to inner and outer periphery sides of a magnetic shielding portion of the armature 5.

The inner periphery of the inner cylindrical portion 4b is formed by cutting so as to permit mounting of the small-diameter bearing 9. An outer periphery surface of the outer cylindrical portion 4c is formed into a concave/convex-free surface. For example, instead of the conventional pulley having multi-stage V-grooves, a worm wheel having a flat inner periphery surface and an outer periphery surface provided with worm teeth is fitted on the outer periphery surface of the outer cylindrical portion 4c. A plurality of bent portions 4e are formed at given intervals as cut and raised portions in the outer cylindrical portion 4c of the rotor 4.

On the other hand, insertion/positioning grooves (not shown) corresponding to the bent portion 4e are formed in the inner surface of the worm wheel. When fitting the worm wheel onto the outer periphery surface of the rotor 4, the fitting is performed while inserting the bent portions 4e into the insertion/positioning grooves to prevent the worm wheel from dislodging.

Formed in the shape of a ring, the armature 5 is made of a magnetic material such as iron, and is disposed in opposition to the frictional surface of the rotor 4, between which a distance is spaced. Slits as magnetic shielding portions are formed in an intermediate portion of the armature 5. While the coil 2 is not energized, the armature 5 can perform both a relative angle displacement and a relative axial displacement with respect to the rotor 4. When the coil 2 is energized, the armature 5 is attracted to the rotor 4, drives the shaft 7 through the hub 6 and rotates together with the rotor 4.

The hub 6 fixes the armature 5 to the shaft 7 so that the armature 5 cannot perform a relative angle displacement but can perform a relative axial displacement with respect to the shaft 7. When the coil 2 is energized, the hub 6 receives a torque from the armature 5 and drives the shaft 7 to rotate together with the armature.

The armature 5 is a magnetic flat plate and is formed with a plurality of magnetic shielding slits by blanking. Its frictional surface for contact with the rotor 4 has been treated with nitriding to improve the wearability. Separating from the rotor 4 and reverting to the original position of the armature 5 are performed by utilizing a spring action of the hub 6.

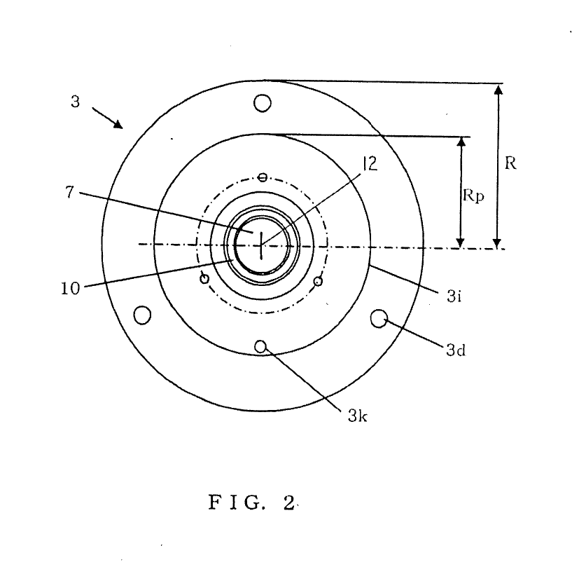

FIG. 2 illustrates a plan view of a stator yoke 3 as seen from the direction of the armature 5. An outside radius of an annular large-outside-diameter plate portion 3b is assumed to be R. In the same figure, the annular vertical surface (axial surface) 3i opposed to an end of an outer cylindrical portion 4c of a rotor 4 is represented as a circle of radius Rp. It is a feature of the present invention that the annular vertical surface 3i perpendicular to the radial direction is present at the position of the radius Rp, which is smaller than R. In the illustrated example, the annular vertical surface 3i is formed as a stepped portion lying at a radially intermediate position of the annular large-outside-diameter plate portion 3b of the stator yoke 3. Since mounting holes 3d are positioned radially outside the stepped portion, the stator yoke 3 can be endowed with both function as part of a magnetic circuit and function as a mounting base for the entire clutch. As seen in FIG. 1, the bottom of the stator yoke 3 is formed into one surface, not requiring any complicated machining.

(Rotor Manufacturing Method)

In the rotor 4, the outer cylindrical portion 4c, the inner cylindrical portion 4b, and the annular small-outside-diameter plate portion 4a contiguous to those portions, are formed so as to give a U-shaped section by stretch drawing with use of a press and necessary machining is applied thereto.

As the material of the rotor 4 there is selected a magnetic material, preferably a low carbon steel such as the cold rolled steel defined by JIS.

(Relation Between End of Outer Cylindrical Portion and Stepped Portion of Stator Yoke)

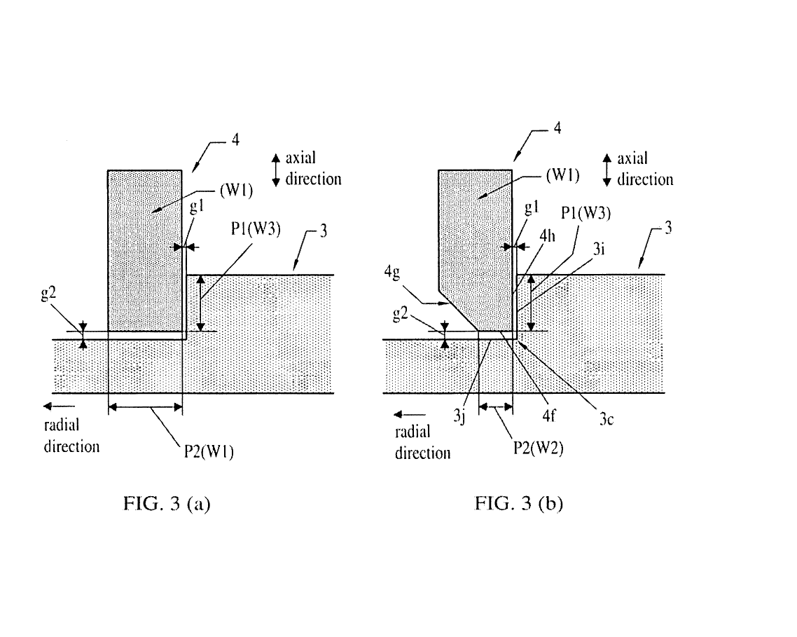

With reference to FIG. 3, a description will now be given about the relation between an axial end (free end) of an outer cylindrical portion 4c of a rotor 4 and a stepped portion 3c of a stator yoke 3. FIG. 3(a) shows an example of a simple shape, in which an end of the outer cylindrical portion 4c of the rotor 4 is not specially deformed. In the illustrated example, a magnetic flux flowing between the upper side of the outer cylindrical portion 4c of the rotor 4 and the right side of the stator yoke 3 mostly passes through a gap of distance g1 between a pair of facing surfaces indicated at P1 (width W3 in this section), but a portion thereof flows downward and passes through a gap of distance g2 between a pair of facing surfaces indicated at P2. The distances g1 and g2 are set in a relation of g1<g2 so that the magnetic flux flow as much as possible through P1.

In FIG. 3(a), the lower opposite surface P2 has a width equal to width W1 in this section of the outer cylindrical portion 4c of the rotor 4, but if the magnetic flux flows much from the lower surface, the rotor 4 undergoes a downward force, so that the amount of wear of the bearings increases, which is not desirable in point of service life of the bearings. Therefore, it is necessary that the amount of magnetic flux flowing from this side be made as small as possible. FIG. 3(b) shows an example of improvement made on this regard.

An axial end (free end) of the outer cylindrical portion 4c of the rotor 4, as shown in FIG. 3, is made up of a lower end surface 4f as a horizontal surface and a slant surface 4g formed by cutting off an outer corner portion of the lower end surface 4f obliquely, the lower end surface 4f and the slant surface 4g being contiguous to each other.

The stepped portion 3c having an annular vertical surface 3i of the stator yoke 3, as seen in a sectional view thereof including the axis (the axis of the stator yoke 3), is constituted by both the annular vertical surface 3i and a horizontal surface 3j orthogonal to the surface 3i. The stepped portion 3c is formed in a shape corresponding to the end shape of the outer cylindrical portion 4c of the rotor 4.

The horizontal width W1 of the outer cylindrical portion 4c of the rotor 4 is larger than width W2 of the end surface 4f of the outer cylindrical portion 4c of the rotor 4.

Since an inner surface 4h of the end of the outer cylindrical portion 4c of the rotor 4 is positioned in proximity to the annular vertical surface 3i perpendicular to the radial direction of the stepped portion 3c, the transmitted magnetic flux mainly passes through the inner surface 4h and the annular surface 3i perpendicular to the radial direction. The attractive force induced by the transmitting magnetic flux passing through the inner surface 4h and the annular vertical surface 3i perpendicular to the radial direction is canceled because it is symmetric with respect to the center of the axis of the rotor 4. In order to reduce the amount of wear of the bearings, minimizing the attractive force in the axial direction of the rotor 4 and the stator yoke 3 and allowing the magnetic flux between the two to flow in the radial direction are necessary, therefore it is desired that the axial length of the pair of facing surfaces of 4h and 3i is long enough for them not to magnetically saturate in case that the passing magnetic flux is at the maximum rated value.

From the standpoint that the larger the amount of the magnetic flux transferred in radial direction, the more advantageous, the inner surface 4h and the annular vertical surface 3i perpendicular to the radial direction are disposed close to each other and long in parallel with each other in the depth direction of the stepped portion 3c shown in FIG. 3(b). The relation between the inner surface 4h and the annular vertical surface 3i is determined in that way. A bottom 3j of the stator yoke 3 is opposed to the lower end face 4f, which is contiguous to the inner surface 4h. It is necessary for the bottom 3i to be spaced away from the lower end face 4f lest an unnecessary axial attractive force (a force applying an unnecessary axial load to a small-diameter bearing 9) should act on the bottom 3i.

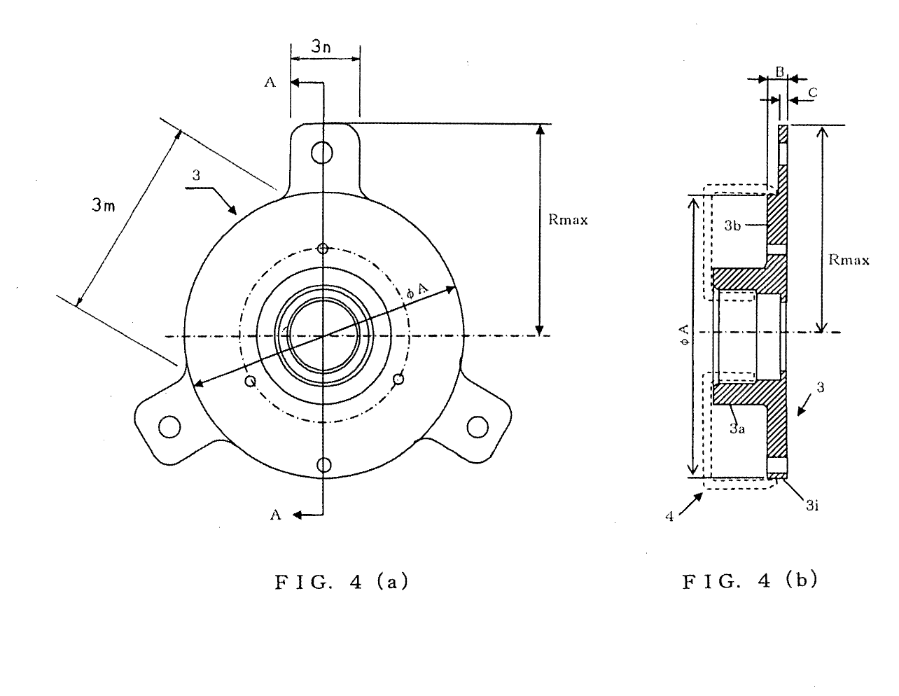

The structure of the stepped portion 3c in the first embodiment requires the annular vertical surface 3i perpendicular to the radial direction and the horizontal surface 3j contiguous perpendicularly to the annular vertical surface 3i. As another example, an annular vertical surface 3i may be provided as part of a circumference, as shown in FIG. 4. Further, the stepped portion 3c may be formed as a slot including the annular vertical surface 3i and the horizontal surface 3j contiguous perpendicularly thereto.

The inner surface 4h is necessary for the outer cylinder portion 4c of the rotor 4 to transfer magnetic flux, but the lower end face 4f and the slant face 4g may be formed in any desired shapes.

The reason why the slant surface is provided is that it is intended to decrease the amount of magnetic flux passing through the lower end surface (exclusive of the slant surface) at the end of the outer cylindrical portion 4c and thereby suppress the force of attracting the rotor 4 in the axial direction, i.e., the axial force applied on the bearings. When the magnetic flux passes through the horizontal surface of the outer cylindrical portion and the axially attracting force acts on the rotor 4, the amount of wear of the bearing provided in the inner cylindrical portion of the rotor becomes large, resulting in the service life of the bearing becoming shorter. Another reason is that the mold for pressing can be removed easily.

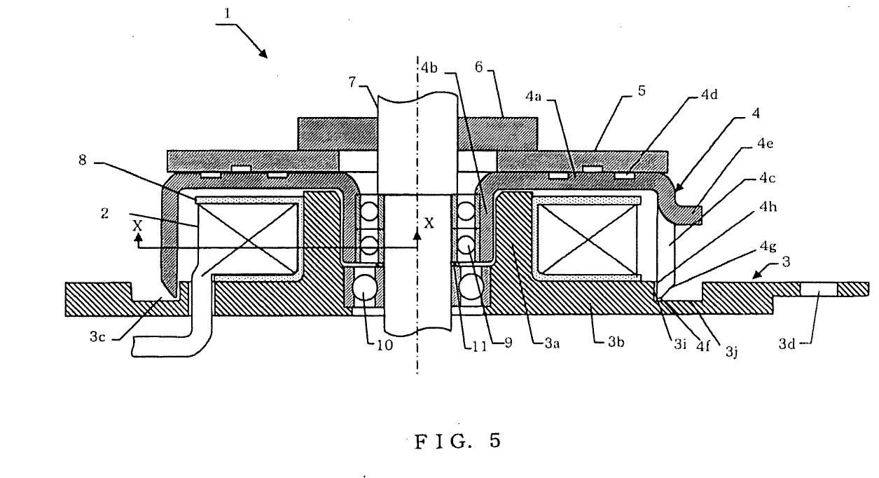

FIG. 4(a) illustrates a plan view of modified form of a stator yoke 3 according to a second embodiment of the present invention. In the figure, φA represents the diameter of an axial surface lying at the stepped portion of the stator as seen axially from above, which axial surface confronts the end of the outer cylindrical portion of a rotor 4. On the other hand, in an annular large-outside-diameter plate portion 3b of the stator yoke 3, each of mounting hole portion (long-diameter portion 3n) is longer in its distance from the center of the axis, as indicated with Rmax. Therefore, said mounting hole portion (long-diameter portion 3n) is longer in diameter than the other portion (short-diameter portion 3m). In the illustrated example, only a part of the opposed surface, where there are the mounting holes, lies at a radially intermediate position as in FIG. 2. FIG. 4(b) is a longitudinal section view of FIG. 4(a), showing a loosely fitted state of the rotor by broken lines. In FIG. 4(b), the portion where there is a mounting hole is thinner by an amount corresponding to the difference in height defined by the opposed surface. A further modification is shown in FIG. 5. In the figure, with respect to an annular large-outside-diameter plate portion 3b of a stator yoke 3, an upper-side height of each of mounting hole portion is made equal to the height of an inner portion. A vertically (axially) upper surface of the mounting hole is made flush with the inner portion, while a lower surface thereof is stepped and made thin. With this stepped portion, the installation height of the clutch is reduced. Thus, this configuration is advantageous to the case where the mounting height is limited. The stepped portion of the lower surface can also be utilized for positioning with respect to the mounting tool on the mating side at the time of mounting the clutch.

(Adjusting Cross-Section Area)

A rotor 4 of a U-shaped section according to the present invention is characteristic in that its configuration is easy to be formed by pressing. As shown in FIG. 1, the rotor 4 having a U-shaped section is made up of an inner cylindrical portion 4b, an outer cylindrical portion 4c, and an annular small-outside-diameter plate portion 4a, which connects between those inner and outer cylindrical portions. An upper surface of the annular small-outside-diameter plate portion 4a serves as a surface of contact with an armature 5.

When forming the rotor 4 from a single steel plate by pressing, the only way to form the inner cylinder portion 4b is to stretch it out from the vicinal portion, so that the wall of the vicinal portion becomes thinner than that of other portion. Moreover, it is necessary that a small-diameter bearing 9 be mounted in the inner cylindrical portion 4b, and if lathing work is performed from the necessity of securing a mounting precision of the bearing, a further reduction of wall thickness results.

On the other hand, it is necessary for an efficient magnetic circuit that neither the inner cylinder portion 4b nor the outer cylinder portion 4c reaches magnetic saturation earlier than the other. It is preferable that both be equal to each other in the area (hereinafter referred to simply as “cross-section area”) of a section perpendicular to the axial direction (the axial direction of the rotor).

Assuming that both are equal to each other in wall thickness, since the inner cylindrical portion 4b lies more inside than the outer cylindrical portion 4c and therefore the cross-section area thereof is smaller than that of the outer cylindrical portion 4c. When the rotor 4 alone is considered, it is preferable for the inner cylindrical portion 4b to be larger in wall thickness than the outer cylindrical portion 4c. However, the reverse is true in the case of the rotor 4 fabricated by stretch draw pressing. The configuration of the electromagnetic clutch of the present invention is convenient for solving this problem. More particularly, unlike the configuration of a conventional U-shaped rotor and a U-shaped housing, in a stator yoke 3 according to the present invention, a thick-walled cylindrical portion 3a is disposed in proximity and opposition to the inner cylindrical portion 4b of the rotor 4 and there is nothing that confronts the outer cylindrical portion 4c of the rotor 4. Therefore, by utilizing the thickness of the thick-walled cylindrical portion 3a of the stator yoke 3 which constitutes a part of the magnetic circuit in proximity of the inner cylindrical portion 4b of the rotor 4 and by setting the cross-section area of a cylindrical portion of a housing so as to satisfy the following relationship: (cross-section area of the inner cylindrical portion 4b)+(cross-section area of the thick-walled cylindrical portion 3a)=(cross-section area of the outer cylindrical portion 4c), it is possible to make the magnetic flux density distribution uniform with respect to both inner and outer peripheries.

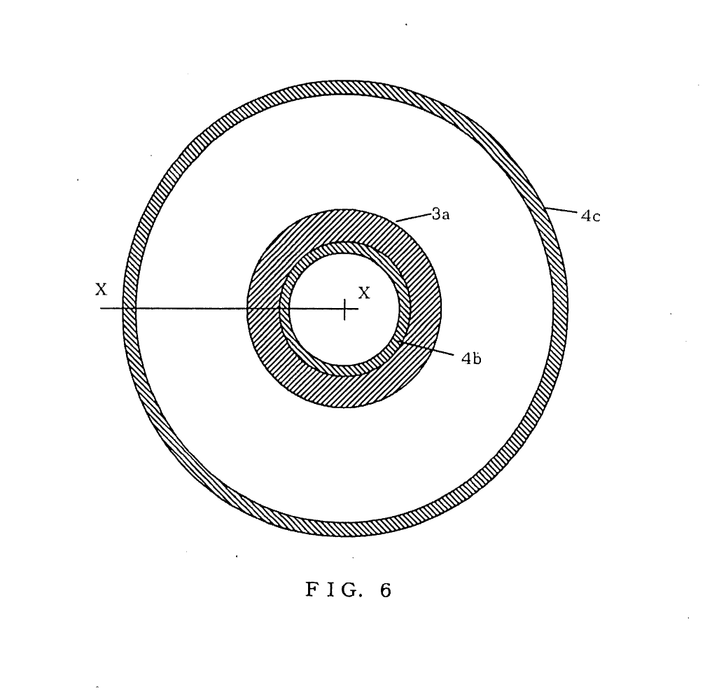

FIG. 6 illustrates a section obtained by cutting along a plane perpendicular to the rotation axis so that X-X in FIG. 5 corresponds to line X-X in FIG. 6. Here, no consideration is given to bent portions 4e, which are for connection of the worm wheel. The influence of the bent portions 4e may be regarded as being little and may be ignored. More strictly, however, as to the outer cylindrical portion of the rotor, the cross-section area of the portion extending downward, exclusive of the bent portions, may be regarded as S2.

### Effect of Embodiments

(1) The stator yoke 3 is formed in L shape in one-side section thereof (a radial section thereof cut from the center of the axis) and is annular when seen in plan view. The L shape is constituted by both the annular large-outside-diameter plate portion 3b disposed horizontally and the thick-walled cylindrical portion 3a, which is integrally contiguous perpendicularly to the annular large-outside-diameter plate portion 3b. The shaft 7 is disposed at the center of the thick-walled cylindrical portion 3a, the large-diameter bearing 10 is disposed between the shaft 7 and the thick-walled cylindrical portion 3a, and the small-diameter bearings 9 is disposed between the shaft 7 and the inner cylindrical portion 4b of the rotor 4. The electromagnetic coil 2 can be supported firmly by the surface of the annular large-outside-diameter plate portion 3b and that of the thick-walled cylindrical portion 3a, and thus can be fixed axially. Moreover, the entire clutch can be fixed through the stator yoke 3 to a base such as, for example, an automobile body. Since the section of the stator yoke 3 is L-shaped, there is no complicated morphological portion, thus facilitating the manufacture of the stator yoke 3. The mounting holes 3d are formed near the outer periphery of the annular large-outside-diameter plate portion 3b.
(2) Since the electromagnetic coil 2 is disposed in contact with both the thick-walled cylindrical portion 3a and the annular large-outside-diameter plate portion 3b of the stator yoke 3 having an L-shaped section, the magnetic flux generated in the electromagnetic coil 2 can be allowed to pass through the thick-walled cylindrical portion 3a and the annular large-diameter plate portion 3b of the stator yoke 3 which are located closest to the electromagnetic coil 2, so that the amount of magnetic flux incapable of acting effectively can be diminished. Since the thickness of the stator yoke 3 is large in the thick-walled cylindrical portion 3a, magnetic resistance is low and so is leaking magnetic flux. Besides, since the section of the stator yoke 3 is L-shaped, the magnetic flux generated by the electromagnetic coil 2 of a quadrangular section (including both square and rectangular shapes) can be effectively utilized.
(3) Since the rotor 4 is formed from a single steel plate by stretch draw pressing, the manufacture thereof becomes easier and the structure thereof becomes simpler. Particularly, since machining of all the portions other than the frictional surface and the bearing-mounting hole can be done by press working, the rotor can be mass-produced automatically on a mass production line. In order to make magnetic flux density constant, the sum of the cross-section areas of the inner cylindrical portion and the thick-walled cylindrical portion of the stator yoke 3 each constituting a magnetic path is made equal to the cross-section area of the outer cylindrical portion, whereby it is possible to improve magnetic characteristics.

Since the rotor 4 can be formed by pressing a single steel plate, output torque of the rotor 4 and magnetic characteristics thereof can be adjusted by adjusting the thickness of the steel plate.

Since the rotor 4 is formed so as to have a U-shaped section, the inner cylindrical portion 4b can be loosely fitted inside the thick-walled cylindrical portion 3a of the stator yoke 3, the annular small-outside-diameter plate portion 4a can be disposed in opposition to the upper end of the thick-walled cylindrical portion 3a of the stator yoke 3 and the upper end of the electromagnetic coil 2, and the outer cylindrical portion 4c can be loosely fitted in the stepped portion 3c having the annular vertical surface 3i perpendicular to the radial direction of the stator yoke 3 while covering the side surface of the electromagnetic coil 2.

Since the inner cylindrical portion 4b is loosely fitted inside the thick-walled cylindrical portion 3a of the stator yoke 3, the inner cylindrical portion 4b and the thick-walled cylindrical portion 3a confront each other over a wide area, so that the leakage of magnetic flux generated in the electromagnetic coil 2 can be diminished and the cross-section area of the magnetic path becomes wider, whereby it is possible to make the magnetic resistance low.

Since the inner cylindrical portion 4b is disposed inside the thick-walled cylindrical portion 3a, it is possible to increase the axial length of the inner cylindrical portion 4b. Accordingly, the mounting area of the small-diameter bearing 9 becomes longer and the rotor can be supported to ensure stable rotation.

Since the annular small-outside-diameter plate portion 4a can be disposed in opposition to the upper end of the thick-walled cylindrical portion 3a of the stator yoke 3 and the upper end of the electromagnetic coil 2, the leakage of magnetic flux generated in the electromagnetic coil 2 can be diminished.

Since the outer cylindrical portion 4c covers the side surface of the electromagnetic coil 2, magnetic flux leakage from the electromagnetic coil 2 can be diminished. Besides, since the slant surface 4g-formed end of the outer cylindrical portion 4c is loosely fitted in the stepped portion 3c having the annular vertical surface 3i perpendicular to the radial direction of the stator yoke 3, it is possible to restrict the path of transmitted magnetic flux and hence possible to suppress the generation of unnecessary axial attractive force.

The stator yoke can support the electromagnetic coil firmly by its two surfaces which are the surface of the annular large-outside-diameter plate portion and the surface of the thick-walled cylindrical portion, and by caulking the upper end of the thick-walled cylindrical portion, it is possible to prevent the electromagnetic coil from dislodging in the axial direction. Moreover, the entire clutch can be fixed through the stator yoke to a base such as, for example, an automobile body. Further, since the stator yoke is L-shaped in section, there is no complicated morphological portion, thus facilitating the manufacture of the stator yoke.

1. An electromagnetic clutch comprising:
a stator yoke;
a rotor; and
an electromagnetic coil,
said stator yoke comprising a thick-walled cylindrical portion and an annular large-outside-diameter plate portion contiguous at an end thereof perpendicularly to said thick-walled cylindrical portion, a radial section cut from the central axis of the cylindrical portion being L-shaped, a stepped portion being formed at a radially intermediate position of said annular large-outside-diameter plate portion, said stepped portion having an annular vertical surface perpendicular to the radial direction,
said rotor comprising an annular small-outside-diameter plate portion, an inner cylindrical portion contiguous at an end thereof perpendicularly to an inner end of said annular small-outside-diameter plate portion, and an outer cylindrical portion contiguous at an end thereof perpendicularly to an outer end of said annular small-outside-diameter portion,
said rotor covering an upper end side of said thick-walled cylindrical portion of said stator yoke and also covering said electromagnetic coil, said inner cylindrical portion of said rotor being loosely fitted inside said thick-walled cylindrical portion, said outer cylindrical portion of said rotor being disposed so that the inside of an end of the outer cylindrical portion confronts the axial surface of said stator yoke.

2. An electromagnetic clutch according to claim 1, wherein an axial end of said outer cylindrical portion of said rotor is formed with a lower end surface and a slant surface contiguous to each other.

3. An electromagnetic clutch according to claim 1, wherein said annular large-outside-diameter plate portion of said stator yoke has a long-diameter portion, said long-diameter portion including a connection portion for fixing the whole of the electromagnetic clutch to a base, and said annular vertical surface perpendicular to the radial direction is formed at an intermediate position in the radial direction of said long-diameter portion.

4. An electromagnetic clutch according to claim 1, wherein said inner cylindrical portion of said rotor is supported by a shaft through small-diameter bearings, said shaft being supported by an inner surface of said thick-walled cylindrical portion of said stator yoke through a large-diameter bearing.

5. An electromagnetic clutch according to claim 1, wherein in a section taken along a plane perpendicular to a rotation axis, the sum of a cross-section area of said inner cylindrical portion of said rotor and that of said thick-walled cylindrical portion of said stator yoke is substantially equal to a cross-section area of said outer cylindrical portion of said rotor.

6. An electromagnetic clutch according to claim 2, wherein said annular large-outside-diameter plate portion of said stator yoke has a long-diameter portion, said long-diameter portion including a connection portion for fixing the whole of the electromagnetic clutch to a base, and said annular vertical surface perpendicular to the radial direction is formed at an intermediate position in the radial direction of said long-diameter portion.

7. An electromagnetic clutch according to claim 6, wherein said inner cylindrical portion of said rotor is supported by a shaft through small-diameter bearings, said shaft being supported by an inner surface of said thick-walled cylindrical portion of said stator yoke through a large-diameter bearing.

8. An electromagnetic clutch according to claim 2, wherein said inner cylindrical portion of said rotor is supported by a shaft through small-diameter bearings, said shaft being supported by an inner surface of said thick-walled cylindrical portion of said stator yoke through a large-diameter bearing.

9. An electromagnetic clutch according to claim 3, wherein said inner cylindrical portion of said rotor is supported by a shaft through small-diameter bearings, said shaft being supported by an inner surface of said thick-walled cylindrical portion of said stator yoke through a large-diameter bearing.

10. An electromagnetic clutch according to claim 9, wherein in a section taken along a plane perpendicular to a rotation axis, the sum of a cross-section area of said inner cylindrical portion of said rotor and that of said thick-walled cylindrical portion of said stator yoke is substantially equal to a cross-section area of said outer cylindrical portion of said rotor.

11. An electromagnetic clutch according to claim 2, wherein in a section taken along a plane perpendicular to a rotation axis, the sum of a cross-section area of said inner cylindrical portion of said rotor and that of said thick-walled cylindrical portion of said stator yoke is substantially equal to a cross-section area of said outer cylindrical portion of said rotor.

12. An electromagnetic clutch according to claim 3, wherein in a section taken along a plane perpendicular to a rotation axis, the sum of a cross-section area of said inner cylindrical portion of said rotor and that of said thick-walled cylindrical portion of said stator yoke is substantially equal to a cross-section area of said outer cylindrical portion of said rotor.

13. An electromagnetic clutch according to claim 4, wherein in a section taken along a plane perpendicular to a rotation axis, the sum of a cross-section area of said inner cylindrical portion of said rotor and that of said thick-walled cylindrical portion of said stator yoke is substantially equal to a cross-section area of said outer cylindrical portion of said rotor.

14. An electromagnetic clutch according to claim 5, wherein in a section taken along a plane perpendicular to a rotation axis, the sum of a cross-section area of said inner cylindrical portion of said rotor and that of said thick-walled cylindrical portion of said stator yoke is substantially equal to a cross-section area of said outer cylindrical portion of said rotor.

15. An electromagnetic clutch according to claim 6, wherein in a section taken along a plane perpendicular to a rotation axis, the sum of a cross-section area of said inner cylindrical portion of said rotor and that of said thick-walled cylindrical portion of said stator yoke is substantially equal to a cross-section area of said outer cylindrical portion of said rotor.

16. An electromagnetic clutch according to claim 7, wherein in a section taken along a plane perpendicular to a rotation axis, the sum of a cross-section area of said inner cylindrical portion of said rotor and that of said thick-walled cylindrical portion of said stator yoke is substantially equal to a cross-section area of said outer cylindrical portion of said rotor.

17. An electromagnetic clutch according to claim 8, wherein in a section taken along a plane perpendicular to a rotation axis, the sum of a cross-section area of said inner cylindrical portion of said rotor and that of said thick-walled cylindrical portion of said stator yoke is substantially equal to a cross-section area of said outer cylindrical portion of said rotor.
